(19) United States
(12) Patent Application Publication
(10) Pub. No.: US 2007/0209897 A1
(43) Pub. Date: Sep. 13, 2007

(54) Hub and synchronizer ring assembly

(75) Inventors: Daisuke Saito, Okazaki-shi (JP); Yukio Ueda, Toyoake-shi (JP); Yoshiyuki Aoyama, Nishio-shi (JP); Satoshi Munakata, Nishikamo-gun (JP)

Correspondence Address: BUCHANAN, INGERSOLL & ROONEY PC, POST OFFICE BOX 1404, ALEXANDRIA, VA, 22313-1404, US

(73) Assignees: AISIN AI Co., Ltd., Nishio-shi (JP); TOYOTA JIDOSHA KABUSHIKI KAISHA, Toyota-shi (JP)

(21) Appl. No.: 11/716,000

(22) Filed: Mar. 9, 2007

(30) Foreign Application Priority Data
Mar. 10, 2006 (JP) 2006-066338

(51) Int. Cl. F16H 61/28

(52) U.S. Cl. 192/53.34

(57) ABSTRACT

A synchronizer ring assembly includes: a synchronizer ring formed with at least one inner peripheral portion; and a hub having an outer peripheral wall at a center of the hub. The synchronizer ring is arranged facing the hub and is coupled with the hub in a spigot manner with the inner peripheral portion of the synchronizer ring being in contact with the outer peripheral wall of the hub.

### CROSS REFERENCE TO RELATED APPLICATIONS

This application is based on and claims priority under 35 U.S.C. § 119 to Japanese Patent Application 2006-066338, filed on Mar. 10, 2006, the entire content of which is incorporated herein by reference.

### FIELD OF THE INVENTION

The present invention generally relates to a hub and synchronizer ring assembly established in a manner of spigot joint.

### BACKGROUND

In conventionally known a hub and synchronizer ring assembly, as clearly illustrated in FIG. 3 and FIG. 4, a synchronizer ring S is formed with multiple protrusions P defined circumferentially at the radially outer portion thereof. A hub H is formed with an outer peripheral portion OP. The synchronizer ring S and the hub H are coupled together in a manner of spigot joint with outer peripheral walls O of the protrusions P being in contact with an inner peripheral wall I of the outer peripheral portion OP. Therefore, a certain amount of play between the synchronizer ring S and the hub H is restrained in a radial direction thereof.

In such above described structure of the hub and synchronizer ring assembly, a tolerance range between the outer peripheral walls O and the inner peripheral wall I is reduced for the purpose of canceling the radial directional play. Because each outer peripheral wall O of the projections P of the synchronizer ring S possesses a forged coarse surface, it is necessary to add a machine finishing, i.e., a lathe turning process to the forged coarse surface. This however may be one of factors that increase a manufacturing cost.

Further, as illustrated in FIG. 5, a hub index type synchronizer ring S is formed with projections T at three portions along its periphery. However, because a lathe tuning process can not be applied to portions of the synchronizer ring S, which need a machine finishing, it is necessary to apply some processing such as the machine finishing by use of other tools or methods. This however may be one of factors that increase a manufacturing cost.

The present invention has been made in view of the above circumstances, and provides a hub and synchronizer ring assembly, in which a synchronizer ring is arranged facing a hub and is mated with the hub in a manner of spigot coupling.

### SUMMARY OF THE INVENTION

A synchronizer ring assembly includes: a synchronizer ring formed with at least one inner peripheral portion; and a hub having an outer peripheral wall at a center of the hub. The synchronizer ring is arranged facing the hub and is coupled with the hub in a spigot manner with the inner peripheral portion of the synchronizer ring being in contact with the outer peripheral wall of the hub.

### BRIEF DESCRIPTION OF THE DRAWINGS

The foregoing and additional features and characteristics of the present invention will become more apparent from the following detailed description considered with reference to the accompanying drawings, wherein:

FIG. 1 is a side view illustrating a synchronizer ring according to an embodiment;

FIG. 2 is a sectional view taken along line II-II in FIG. 1;

FIG. 3 is a side view illustrating a synchronizer ring according to a conventional work;

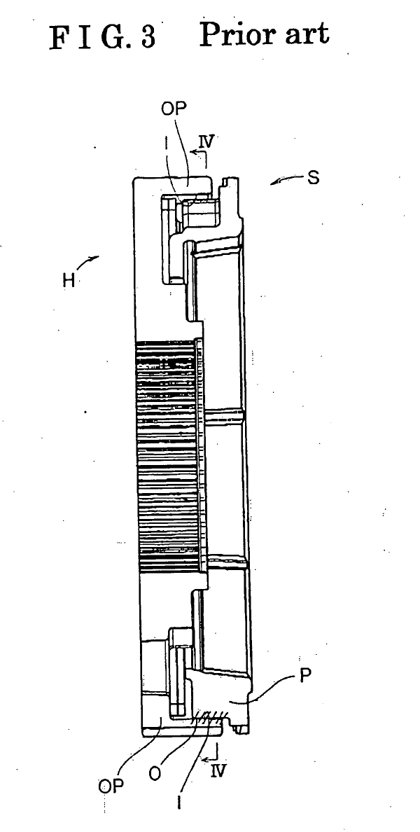

FIG. 4 is a sectional view taken along line IV-IV in FIG. 3; and

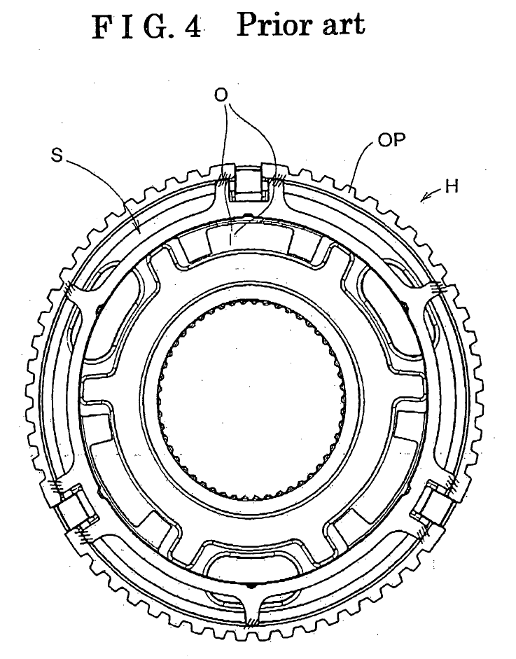

FIG. 5 is a front view illustrating a hub-index type synchronizer ring of a conventional work.

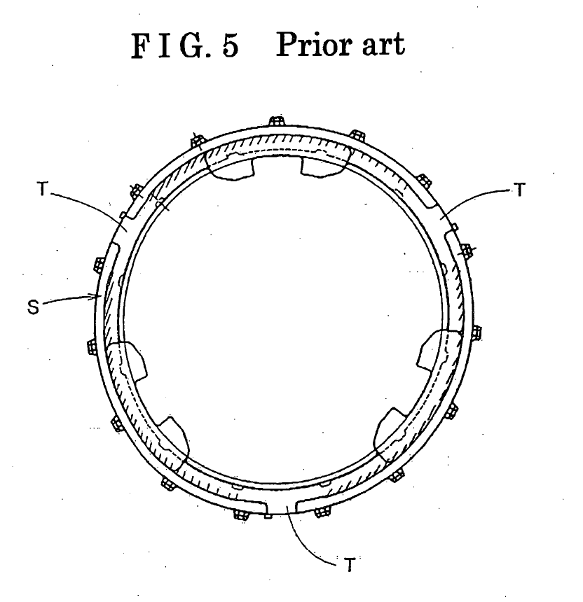

### DETAILED DESCRIPTION

Described below is a hub and synchronizer ring assembly according to an embodiment of the present invention, with reference to the attached drawings.

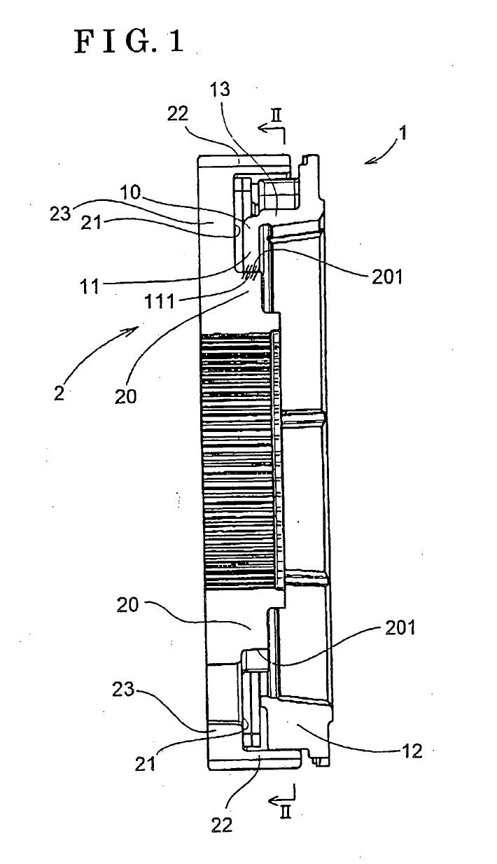

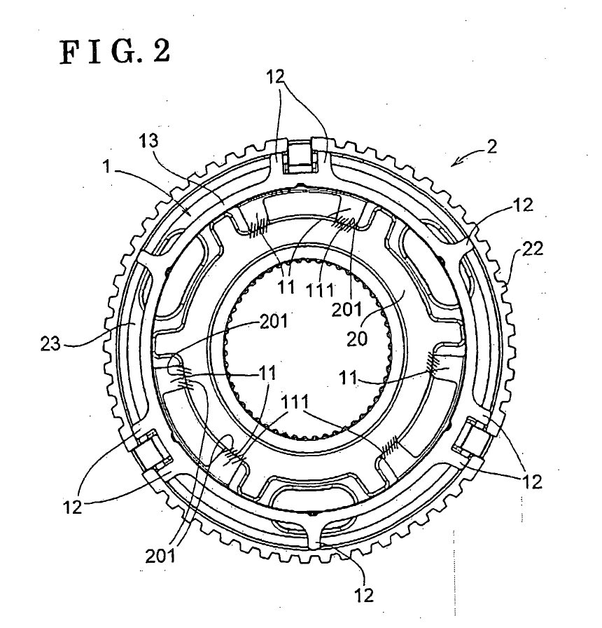

As illustrated in FIG. 1 and FIG. 2, a synchronizer ring 1 is formed with a plurality of claws or hooks 11 each having inner peripheral wall 111. A hub 2 includes a boss 20 having an outer peripheral wall 201. That is, the outer peripheral wall 201 is defined at or near a center of the hub 2. The synchronizer ring 1 and the hub 2 are connected to each other in a manner of spigot coupling with the inner peripheral walls 111 of the claws 11 being in contact with the outer peripheral wall 201 of the hub 2.

The hub 2 is formed with an annular-shaped recess 21 that is coaxial with the hub 2. The synchronizer hub 2 further includes the boss 20, which extends in the axial direction at the centre of the hub 2; another outer peripheral wall 22, which is formed at an outer periphery of the hub 2 and extends in the axial direction thereof; and a connection 23, which connects the boss 20 to the outer peripheral wall 22 and extends in a radial direction. The outer peripheral wall 22 of the hub 2 is splined at an outer periphery thereof.

The synchronizer ring 1 includes an annular portion 10, which is arranged to be coaxial with the hub 2 and partially faces the hub 2 along the axis, and multiple protrusions 12, which protrude from an outer periphery of the synchronizer ring 1 outwardly in a radial direction. The annular portion 10 includes the multiple claws 11, which are housed or inserted in the annular-shaped recess 21 of the hub 2 and extend radially; and a circumferential portion 13, which extends radially and connects the protrusions 12 to the claws 11. The annular portion 10 exhibits an approximately Z-shaped in a cross section.

The multiple claws 11 of the synchronizer ring 1 are housed in the annular-shaped recess 21 of the hub 2 and extend in the radial direction.

An inner peripheral portion or inner peripheral portions of the synchronizer ring 1 is structured by the inner peripheral walls 111 of the claws 11 of the synchronizer ring 1. The claws 11 are housed in the annular-shaped recess 21 of the hub 2 and extend in the radial direction. The inner peripheral walls 111 of the claws 11 have been already machined or processed.

Because the annular-shaped recess 21 is formed to be coaxial with the synchronizer hub 2, the outer peripheral wall 201 of the boss 20 comes in contact with the inner peripheral claws 111 of the claws 11 of the synchronizer ring 1, which claws 11 are housed in the recess 21 of the hub 2 and extend in the radial direction. As a result, the outer peripheral wall 201 and the inner peripheral walls 111 establish a spigot configuration and thus restarting an amount of play of the synchronizer ring 1 in the radial direction.

According to the hub and synchronizer ring assembly of the embodiment of the present invention, the annular-shaped recess 21 is formed at the hub 2. The outer peripheral wall 201 of the boss 20, which structures the spigot coupling and extends in the radial direction at the center of the hub 2, comes in contact with the inner peripheral walls 111 of the claws 11 that are housed in the annular-shaped recess 21 and extend in the radial direction. Therefore, this contact restrains or reduces a play or looseness of the synchronizer ring 1 in the radial direction.

The inner peripheral walls 111 of the claws 11 of the synchronizer ring 1 are the inner peripheral surfaces or portions as contact portions of the synchronizer ring 1. Such inner peripheral walls 111 of the claws 11 come in contact with the outer peripheral wall 201 of the boss 20 of the hub 2, and thus restraining the looseness of the synchronizer ring 1 in the radial direction.

The claws 11 are located at the side of the center of the synchronizer ring 1 and are housed in the annular-shaped recess 21 of the hub 2. The inner peripheral walls 111 of the claws 11 of the synchronizer ring 1 come in contact with the outer peripheral wall 201 of the boss 20 positioned at the side of the center of the hub 2. Therefore, it is possible not to generate force imbalanced in the radial direction and restrain looseness of the synchronizer ring 1 in the radial direction.

The inner peripheral portions of the synchronizer ring 1, which serve as the contact portions of the synchronizer ring 1 that restrain the looseness of the synchronizer ring 1 in the radial direction, are structured by the inner peripheral walls 111 of the claws 11 of the synchronizer ring 1. The inner peripheral walls 111 and the claws 11 are not newly formed at the synchronizer ring 1 of the embodiment of the present invention and are conventionally formed at the synchronizer ring 1. Therefore, there is no need to add another processing, such as cutting and processing, thus leading to the reduction of the manufacturing cost.

Further, the outer peripheral wall 201 of the boss 20, which serves as the outer peripheral surface of the boss 20 of the hub 2, is a contact portion as well. The contact portions of the synchronizer ring 1 and the hub 2 are hatched in FIG. 1 and FIG. 2 and the these hatched portions are referred to as spigot portions. That is, the synchronizer ring 1 and the hub 2 are mated with each other in a spigot-coupling manner, thus restraining play or looseness in the radial direction.

In the situation where we need to reduce or cancel a play or looseness of the synchronizer ring 1 relative to the hub 2, because the inner peripheral walls 111 of the claws 11 have been applied with a cutting and processing for other reasons or purposes, other processing are not needed newly. As a result, the spigot-coupling of the hub and synchronizer ring assembly according to the embodiment is not a factor in the increase of the manufacturing cost.

It may be possible to reduce or restrain a play or looseness in the radial direction, with a conventional hub and synchronizer ring assembly applied with a cutting and processing. In this case, the same or similar function can be achieved as the hub and synchronizer ring assembly of the embodiment. However, according to the embodiment, this spigot-coupling structure does not require another cutting and processing and excels in the manufacturing cost.

As described above, according to the embodiment, the inner peripheral walls 111 of the claws 11 of the synchronizer ring 1 are the contact portions (spigot-coupled portions), and the outer peripheral wall 201 of the boss 20 positioned at the side of the center of the hub 2 are the contact portions (spigot-coupled portions) as well. However, the present invention is not limited to the above, and other portions, which are located at the sides of the centers of the synchronizer ring 1 and the hub 2, can be employed as contact portions (spigot-coupled portions).

As described above, the inner peripheral walls 111 of the claws 11 of the synchronizer ring 1 come in contact with the outer peripheral wall 201 of the boss 20 of the hub 2. As a result, the synchronizer ring 1 and the hub 2, i.e., the inner peripheral walls 111 and the outer peripheral wall 201, establish a spigot-coupled structure. Therefore, it is possible to restrain a play or looseness of the synchronizer ring 1 without a new cutting and processing applied to the synchronizer ring 1 or the hub 2, while force imbalanced in the radial direction is not generated.

The inner peripheral portion of the synchronizer ring comes in contact with the outer peripheral wall at the side of the center of the hub, so that a spigot-structure is established. Therefore, without generating force imbalanced in the radial direction, a play or looseness of the synchronizer ring in the radial direction is restrained.

The outer peripheral wall of the boss of the hub structures the outer peripheral wall at the side of the center of the hub. The outer peripheral wall of the boss comes in contact with the inner peripheral portion of the synchronizer ring. Therefore, without generating force imbalanced in the radial direction, a play or looseness of the synchronizer ring in the radial direction is restrained.

The inner peripheral wall of the claw of the synchronizer ring structures the inner peripheral portion of the synchronizer ring. The inner peripheral wall of the claw comes in contact with the outer peripheral wall of the boss of the hub. Therefore, it is possible to restrain a play or looseness of the synchronizer ring without a new cutting and processing applied to the synchronizer ring 1 or the hub, while force imbalanced in the radial direction is not generated.

The boss is positioned at the center of the hub and includes the outer peripheral wall extending in the axial direction. The boss is formed with the annular-shaped recess. Such outer peripheral wall comes in contact with the inner peripheral portion of the synchronizer ring. Therefore, it is possible to restrain a play or looseness of the synchronizer ring without a new cutting and processing applied to the synchronizer ring 1 or the hub, while force imbalanced in the radial direction is not generated.

The principles, of the preferred embodiment and mode of operation of the present invention have been described in the foregoing specification. However, the invention, which is intended to be protected, is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A synchronizer ring assembly comprising:
a synchronizer ring formed with at least one inner peripheral portion; and
a hub having an outer peripheral wall at a center of the hub,
wherein the synchronizer ring is arranged facing the hub and is coupled with the hub in a spigot manner with the inner peripheral portion of the synchronizer ring being in contact with the outer peripheral wall of the hub.

2. A synchronizer ring assembly according to claim 1, wherein the outer peripheral wall of the hub is an outer peripheral wall of a boss of the hub.

3. A synchronizer ring assembly according to claim 1, wherein the synchronizer ring further includes at least one claw and the inner peripheral portion of the synchronizer ring is an inner peripheral wall of the claw.

4. A synchronizer ring assembly according to claim 2, wherein the synchronizer ring further includes at least one claw and the inner peripheral portion of the synchronizer ring is an inner peripheral wall of the claw.

5. A synchronizer ring assembly according to claim 4, wherein the hub is formed with an annular-shaped recess and the boss of the hub extends axially at the center of the hub.

6. A synchronizer ring assembly according to claim 4, wherein the claw of the synchronizer ring is inserted into the annular-shaped recess and extends in a radial direction.

7. A synchronizer ring assembly according to claim 5, wherein the claw of the synchronizer ring is inserted into the annular-shaped recess and extends in a radial direction.
